(19) United States
(12) Patent Application Publication
(10) Pub. No.: US 2003/0053206 A1
(43) Pub. Date: Mar. 20, 2003

(54) Display apparatus

(76) Inventor: Takayoshi Togino, Tokyo (JP)

Correspondence Address: Pillsbury Madison & Sutro LLP, Intellectual Property Group, East Tower, Ninth Floor, 1100 New York Avenue, N.W., Washington, DC, 20005-3918, US

(21) Appl. No.: 10/119,114

(22) Filed: Apr. 10, 2002

(30) Foreign Application Priority Data
Apr. 10, 2001 (JP) 2001-111153

(51) Int. Cl. G03B 21/22

(52) U.S. Cl. 359/434; 353/71

(57) ABSTRACT

The present invention relates to an optical system of a small-sized portable display apparatus in which the exit pupil position is relatively spaced apart from the optical system and the exit pupil's diameter is large. A display apparatus comprises a display element 3 for displaying an image, and an ocular optical system 32 for enlarging an image displayed on said display element or an intermediated image thereof as a virtual image, and is characterized in that the ocular optical system 32 has rotationally asymmetric Fresnel surfaces 21, 22.

This application claims benefit of Japanese Application No. 2001-111153 filed in Japan on Apr. 10, 2001, the contents of which are incorporated by this reference.

### BACKGROUND OF THE INVENTION

The present invention relates to a display apparatus and, more particularly to a portable display apparatus, such as a small-sized projection-type display apparatus, using a Fresnel optical element which is rotationally asymmetric and which produce little aberrations such as image distortion even though it is disposed in a decentered position.

As means for correcting decentration aberrations of a decentered optical system, optical systems using a rotationally asymmetric surface for correcting decentration aberrations have been proposed in Japanese Patent Unexamined Publication H05-303054, Japanese Patent Unexamined Publication H05-323229, and the like. There are also apparatuses comprising one reflecting surface or two reflecting surfaces as disclosed in Japanese Patent Unexamined Publication H08-184780, Japanese Patent Unexamined Publication H08-240773.

Conventional ocular optical system using a rotationally asymmetric reflecting surface have been designed for use as a head-mounting type display apparatus so that an exit pupil position in the ocular optical system corresponding to the pupil of observer's eyeball is relatively close to the optical system. The exit pupil of the ocular optical system has small diameter. When the display apparatus is used as a potable display apparatus, the display must allow the observer's eyes to be positioned at a somewhat long distance from the display apparatus to view the display. However, since the exit pupil position in the conventional ocular optical system is relatively close to the optical system and the exit pupil's diameter is small, the conventional optical system can not be used for a portable display apparatus.

### SUMMARY OF THE INVENTION

The present invention has been made in order to solve the aforementioned problems of the conventional systems. It is an object of the present invention to provide an optical system of a small-sized portable display apparatus in which the exit pupil position is relatively spaced apart from the optical system and the exit pupil's diameter is large.

To achieve the aforementioned object, a display apparatus of the present invention comprises: a display element for displaying an image, and an ocular optical system for enlarging an image displayed on said display element or an intermediated image thereof as a virtual image, and is characterized in that said ocular optical system has a rotationally asymmetric Fresnel surface.

In this case, it is preferable that the rotationally asymmetric Fresnel surface is composed of a free-form surface.

In addition, it is preferable that the rotationally asymmetric Fresnel surface is disposed in a decentered position and is arranged to correct decentration aberrations created due to its decentration.

The reasons why the present invention employs the aforementioned structure and its works will be described below.

The fact that decentration aberrations created by decentered optical surface can be corrected by a rotationally asymmetric surface has been disclosed in some prior arts including the aforementioned publications: Japanese Patent Unexamined Publication H05-303054, Japanese Patent Unexamined Publication H05-323229, Japanese Patent Unexamined Publication H08-184780, and Japanese Patent Unexamined Publication H08-240773. However, the typical rotationally asymmetric surface is a curved surface because of spherical segment.

As for a portable type display apparatus as the subject of the present invention, it is important that its ocular optical system can be folded to be accommodated. The present invention is characterized by employing a Fresnel surface as the ocular optical system, thereby enabling the ocular optical system to be folded to be thinner.

The aforementioned prior arts have been invented for an apparatus to be mounted on an observer's head. Therefore, to miniaturize the apparatus and to prevent the optical system from largely projecting in front of the observer, the distance (eye-relief) between the ocular optical system and the exit pupil is designed to be relatively short. As for a portable type display apparatus as the subject of the present invention, however, it is important to arrange the eye-relief to be in the order of 30 cm. This is because it is desirable that the observer can perceive every corner of the display without vignetting even when the observer's eyes are some apart from the display, for example, in case of using it in a crowed train i.e. taking it out of his/her pocket, taking a look at the display, and returning it to the pocket.

Therefore, in the present invention, the focal length of the ocular optical system is optimized so as to allow the observer to view the entire display even when the display apparatus is held 50 mm or more apart from his eyes. For this, it is important to arrange the exit pupil in the ocular optical system 80 mm or more apart form the ocular optical system.

That is, it is preferable to satisfy the following conditional expression:

80 mm<EXPe<1000 mm (1)

wherein EXPe is the axial distance from the exit pupil position in the ocular optical system to a surface of the ocular optical system facing the exit pupil. When EXPe is shorter than 80 mm as the lower limit defined by the above expression, the observer is allowed to observe the entire display only when bringing the apparatus close his eyes, that is, the observer hardly views the display. Further, with EXPe shorter than the lower limit, when the observer want to operate operational button(s) or switch(es) disposed on the apparatus, the distance between the apparatus and the observer's face should be too short to bring his finger(s) between the apparatus and his face to operate the apparatus. On the other hand, when EXPe is longer than the upper limit of 1000 mm, the observer should bring the apparatus too far from his/her eyes to see so that the observer can not see small objects or characters in an image on the display. Further, the distance therebetween should be too long to touch the operational buttons. In this state, the observer can not operate the buttons.

It is further preferable to satisfy the following conditional expression:

100 mm<EXPe<1000 mm (1-1)

When EXPe is shorter than the lower limit of 100 mm, the observer should not be allowed to bring his hand between the display apparatus and his face to operate the operational buttons. In this state, the observer can not operate while viewing the display.

It is further preferable to satisfy the following conditional expression:

300 mm<EXPe<1000 mm (1-2)

When EXPe is shorter than the lower limit of 300 mm, the distance is shorter than the distance for clearly seeing images on the display so that it is hard to view images on the display while operating the operational buttons.

It is still further preferable that the Fresnel surface is composed of a reflecting surface, whereby an image display apparatus can be arranged as shown in FIG. 1. In FIG. 1, an ocular optical system 32 comprises a Fresnel reflecting surface 34. Employment of the Fresnel surface as a reflecting surface can significantly reduce the creation of chromatic aberrations on pupils that is a phenomenon in which the observer sees unusual colors on the display when the observer moves his/her eyes E.

It is further preferable that the Fresnel surface is composed of a transparent surface, whereby an image display apparatus can be arranged as shown in FIG. 2. In FIG. 2, an ocular optical system 32 comprises a Fresnel transparent surface 35. In this case, the light source side, i.e. the opposite side of the eyes E, relative to the Fresnel transparent surface 35 can be completely shaded from light, thereby preventing undesirable extraneous light from entering the irradiation side of the Fresnel transparent surface 35 and thus avoiding the affect of the extraneous light. Therefore, the observer can see clear images.

It is preferable that the Fresnel surface is arranged to be tilt, whereby the optical system can be structured smaller and the apparatus can be miniaturized. In addition, it is preferable to employ a rotationally asymmetric surface, capable of correcting decentration aberrations created on the tilt Fresnel surface, as the Fresnel surface, the decentration aberrations can be corrected.

It is further preferable that the Fresnel surface is composed of a free-form surface having a rotationally asymmetric surface configuration, whereby the decentration aberrations can be corrected by a less number of surfaces.

The free-form surface used in the present invention is a free-form surface defined by the equation (a) of U.S. Pat. No. 6,124,989 (Japanese Patent Unexamined Publication 2000-66105). The Z-axis of the defining equation is the axis of the free-form surface.

To correct image distortion produced due to decentration, the Fresnel surface having a rotationally asymmetric surface configuration should be made to have partial power of which the convergent function is gradually stronger with getting closer to the direction toward the position of the display element. Since the image distortion may be trapezoidal, this exhibits an effect of correcting a portion, corresponding to the bottom of the trapezoid, where image should be relatively large.

When the optical axial direction is defined as the direction of a Z-axis, the decentering direction of the optical plane is defined as the direction of a Y-axis, and the direction perpendicular to the aforementioned both directions is defined as the direction of an X-axis, powers in the X- and Y-directions should be made gradually stronger with getting closer to the direction toward the position of the display element. The power of the plane in the X-direction is required to correct image distortion, which may be trapezoidal, produced due to decentration. When the curvature of a plane having convergent function is defined as positive and the curvature of a plane having divergent function is defined as negative, it is preferable that the curvature in the X-direction is gradually stronger in positive direction with getting closer to the direction toward the position of the display element. Since the image distortion may be trapezoidal, this exhibits an effect of largely expanding an upper portion of an image to equalize the upper side and the bottom side of the image.

Similarly to the power in the Y-direction, when the curvature of a plane having convergent function is defined as positive and the curvature of a plane having divergent function is defined as negative, it is preferable that the power in the Y-direction is gradually stronger in positive direction with getting closer to the direction toward the position of the display element. This exhibits an effect of equalizing the height of an upper half and the height of a lower half of the image about the optical axis.

In case that the optical system is composed of two Fresnel reflecting surfaces, at least either one of the surfaces satisfies the above conditions, thereby reducing the occurrence of image distortion produced due to decentration.

As for each of Examples 1 through 3, as described later, positions where upper-, lower-, and right-side (reference) principal rays of the display collide with the Fresnel reflecting surface, and curvatures (mm⁻¹) of the Fresnel reflecting surface are shown in below. Each image display element is located at the lower side.

Example 1
EXPe 300 mm

| | Principal | Curvature | Curvature |
|---|---|---|---|
| | ray coordinate | in X-direction | in Y-direction |
| Upper | 20.74306 | 0.00742 | 0.00536 |
| Lower | −21.90212 | 0.00774 | 0.00769 |
| Right | 26.24660 | 0.00647 | 0.00549 |

Example 2
EXPe 300 mm

| | Principal | Curvature | Curvature |
|---|---|---|---|
| | ray coordinate | in X-direction | in Y-direction |
| First Surface | | | |
| Upper | 13.82870 | −0.00203 | −0.00250 |
| Lower | −14.60141 | −0.00018 | 0.00166 |
| Right | 17.49773 | −0.00032 | 0.00003 |
| Second Surface | | | |
| Upper | 19.40911 | 0.00892 | 0.00705 |
| Lower | −16.46791 | 0.00851 | 0.00612 |
| Right | 23.90501 | 0.00735 | 0.00666 |

Example 3
EXPe 200 mm

| | Principal | Curvature | Curvature |
|---|---|---|---|
| | ray coordinate | in X-direction | in Y-direction |
| First Surface | | | |
| Upper | 14.94386 | −0.00580 | −0.00403 |
| Lower | −15.95127 | −0.00676 | −0.00621 |
| Right | 10.48902 | −0.00631 | −0.00523 |
| Second Surface | | | |
| Upper | 14.45719 | 0.00067 | −0.000325 |
| Lower | −16.77110 | 0.00635 | 0.00469 |
| Right | 6.46135 | 0.00289 | 0.00076 |

By the way, in case of using a small sized display element, magnification may be insufficient only by the ocular optical system, not to obtain an image having enough size. In this case, it is important to use a relay optical system to enlarge and project the image of the display element prior to the ocular optical system. The image once projected by the relay optical system is further enlarged by the ocular optical system.

By employing a decentered prism optical system as the relay optical system for enlarging and projecting an image of a small-sized display element to a position near the ocular optical system, the relay optical system can be structured small. Hereinafter, the reason adopting a decentered prism optical system as the relay optical system will be explained.

In case of using the display apparatus of the present invention as a projecting optical element as mentioned above, it is preferable that the relay optical system is a decentered prism optical system composed of a prism member made of a medium of which refractive index (n) is greater than 1, i.e. n>1, and that the prism member includes an incident facet which allows light beam from said display element to enter the prism, at least one reflecting facet which reflects the light beam inside the prism, and an exit facet which allows the light beam to exit from the prism, wherein said at least one reflecting facet has a curved surface configuration imparting power to the light beam. The curved surface configuration is rotationally asymmetric surface configuration for correcting aberrations created due to the decentration. The reflecting surface of the prism member has preferably rotationally asymmetric surface configuration for imparting power to the light beam during reflection and, in addition, correcting the aberrations created due to the decentration.

In case of a refracting optical element such as a lens, power can be imparted to the refracting optical element by providing curvature to a boundary surface of the refracting optical element. Therefore, the occurrence of chromatic aberrations is inevitable during light ray is refracted at the boundary surface of the lens due to chromatic dispersion property of the refracting optical element. As a result, adding another refracting optical element is a typical way for correcting the chromatic aberrations.

On the other hand, in case of a reflecting optical element such as a mirror, prism, or the like, power can be imparted to a reflecting surface of the reflecting optical element. In this case, however, chromatic aberrations are not occurred according to the principle. Therefore, it is not necessary to add another optical element only for the purpose of correcting the chromatic aberrations. Therefore, from the point of view of chromatic aberrations, an optical system employing reflecting optical elements can be composed of reduced number of elements as compared to an optical system employing refracting optical elements.

In addition, in the reflecting optical system employing reflecting optical elements, the optical paths are folded, thereby reducing the size of the optical system itself as compared to the optical system employing refracting optical elements.

Since the reflecting surface has high sensitivity of decentering error as compared to the refracting surface, high accuracy is required to adjust the assembly. Among reflecting optical elements, a prism has fixed positional relation between its respective surfaces. Therefore, accuracy is only required to control the decentration of the prism itself so that significantly high accuracy and a large number of steps for adjust the assembly are not required.

In addition, the prism has an incident facet and an exit facet, which are refracting surfaces, in addition to a reflecting surface. Therefore, the prism has increased degree of freedom relative to the correction of aberrations as compared to a mirror having a reflecting surface only. In particular, desired large parts of power are shared by the reflecting surface so as to reduce the power shared by the incident facet and the exit facet as the refracting surfaces, whereby the occurrence of chromatic aberrations can be significantly reduced as compared to a refracting optical element such as lens, with still holding the degree of freedom relative to the correction of aberrations higher than that of a mirror. Since the inside of the prism is filled with transparent medium of which refraction index is higher than that of air, the prism has an optical path length longer than that of air. Therefore, the optical system employing the prism can be designed to be thinner and smaller than that employing lenses or mirrors which are disposed in the air.

In case of a projecting optical system, well focusing property is required not only for the center but also for the periphery. In case of a general co-axial optical system, the signs of rays in height out of the axis are reversed at a stop so that the rays have opposite signs after the stop, thus losing the symmetry property relative to the stop of the optical element, thus increasing the “off-axis” aberrations (coma). For this, refracting surfaces are normally disposed to sandwich the stop to satisfy the symmetry property relative to the stop, thereby correcting the “off-axis” aberrations.

As mentioned above, in case that an image on a display element is enlarged and projected by a relay optical system and then the projected image is further enlarged by an ocular optical system, a prism member is employed which comprises an incident facet which allows light beam from a display element to enter the prism, at least one reflecting facet which reflects the light beam inside the prism, and an exit facet which allows the light beam to exit from the prism, wherein said at least one reflecting facet has a curved surface configuration imparting power to the light beam and the curved surface configuration is rotationally asymmetric surface configuration for correcting aberrations created due to the decentration so as to correct the decentration aberrations, thereby enabling the well correction not only for aberrations at the center but also for the “off-axis” aberrations.

Accordingly, the present invention enables to make a small-size and high-performance relay optical system because an image displayed on a display element can be enlarged and projected to a position near an ocular optical system by employing decentered prism optical system using the prism member.

Now, an ocular optical system comprising a Fresnel surface will be described. In the following examples with concrete numerical values, the ocular optical system is shown as a surface having no diffusion property. However, the ocular optical system is preferably provided with somewhat diffusion property. The following are the reasons.

As shown in FIG. 3, an ocular optical system 32 disposed near the projected image should have low scattering property to selectively orient scattered light 52 toward the observer. As shown in FIG. 4, an ocular optical system 32 having high scattering property is normally preferable because illumination irregularities are hardly produced. However, since the present invention pertains to a portable type display apparatus normally for a single observer, the amount of rays reaching the observer's eyes must be extremely small relative to the amount of incident light 51 when the incident light 51 is scattered. This is waste of light output. In addition, as the brightness of light output is increased to compensate the brightness of the display which is dark due to the scattering of light, consumed power is increased, thus extremely shortening the operating time or increasing the size and weight of the buttery. This makes the reduction in size of the display apparatus nonsense. To avoid this problem, as shown in FIG. 3, it is important for the ocular optical system 32 of this invention to use a screen of which scattering property is low. Though the ocular optical system 32 is shown as an optical element having reflecting function in FIG. 3 and FIG. 4, this is the same as for a case employing an optical element having transparent function.

The employment of the screen having low diffusion property is preferable in view of prevention against being peeked by someone around the observer when viewing displayed contents, for example, in a train. If the screen has high diffusion property, the displayed contents can be peeked by someone sitting next to the observer.

It is further preferable in view of effective utilization of light that the diffusion property of the screen is set in such a manner that the diffusion light intensity in directions having an angle of 20° relative to the direction of the incident light is 50% or less of the light intensity in the direction regularly reflected at the optical surface of the ocular optical system 32. It is still further preferable that the screen has lower scattering property in which the diffusion light intensity in directions having an angle of 10° relative to the direction of the incident light is 50% or less of the light intensity in the direction regularly reflected at the optical surface.

As shown in FIG. 5, the scattering range 53 of the ocular optical system 32 is preferably set in such a manner that the width in the horizontal direction is larger than that in the vertical direction to correspond to the position of the observer's eyes. With the scattering range 53 having the horizontal width larger than the vertical width, light beams can be effectively guided from the relay optical system 31 to the observer's eyes, thereby allowing the display to be observed by both eyes.

As shown in FIG. 6, the ocular optical system 32 is preferably provided with diffraction optical elements (DOE) or hologram optical elements (HOE) so as to divide a beam emitted from the relay optical system 31 into two groups directing toward the eyes of the observer, respectively, thereby obtaining further efficient diffusion range 53. The same effect can be obtained by using a prism sheet which is formed by aligning one-dimensional micro prisms of which top angle is obtuse angle.

According to the present invention, the apparatus is designed to display a virtual image to be observed by the observer's eyeballs at a point near the ocular optical system 32, more preferably, designed to display the virtual image at a point closer to the observer than the surface of the ocular optical system 32, thereby giving the improved feeling of being at a live performance. In case that the surface of the ocular optical system 32 has such diffusion property as mentioned, the position of the virtual image is coincided with the surface of the ocular optical system 32 having diffusion property, thereby obtaining clear images. Particularly in case of less number of pixels for display, the image display position is very slightly shifted from the surface having the diffusion property, whereby smooth image can be given because of the effect of low-pass filter.

When an image of a display element is enlarged and projected by a relay optical system and, after that, is further enlarged by an ocular optical system, as shown in FIG. 7, two relay optical systems 31R, 31L are employed, right and left display elements are arranged to correspond to the relay optical systems 31R, 31L, respectively, and an ocular optical system 32 is used commonly, and binocular parallax images are displayed on the display elements, respectively. By separating optical paths from the right and left display elements into two toward the right and left eyes, the apparatus can provide an image with parallax for the right and left eyes of the observer, thereby enabling the observer to see a three-dimensional image with his/her two eyes. That is, the display apparatus can provide a three-dimensional image to be viewed without using special glasses.

It is desirable that the position of a virtual image formed by the ocular optical system is movable from an infinite point to a point near the ocular optical system. This can be achieved by providing a mechanism for moving the display element in the optical axial direction to move the actual image to be projected by the relay optical system. Because of this mechanism, the virtual image can be formed at a position desired by the observer, thereby selecting the visible image display position according to the observer who is, for example, nearsighted or farsighted.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is an illustration for explaining one usage of a display apparatus of the present invention;

FIG. 2 is an illustration for explaining another usage of a display apparatus of the present invention;

FIG. 3 is an illustration for explaining scattering property of an ocular optical system of the display apparatus of the present invention;

FIG. 4 is an illustration similar to FIG. 3, but showing a case of great scattering property;

FIG. 5 is an illustration of the display apparatus of the present invention where the scattering range of the ocular optical system in the horizontal direction relative to observer's eyeballs is greater than that in the vertical direction;

FIG. 6 is an illustration of the display apparatus of the present invention where a light ray from a relay optical system is divided into two groups toward the observer's eyeballs, respectively;

FIG. 7 is an illustration of the display apparatus of the present invention which employs two relay optical systems to enable the observer to see three-dimensional images,

FIG. 8 is an illustration for explaining an arrangement enabling the display apparatus of the present invention to be used as a projector;

FIG. 9 is an illustration for explaining an arrangement of the display apparatus of the present invention as a hand-held viewer;

FIG. 10 is an illustration for explaining another arrangement of the display apparatus of the present invention in which a member for supporting a relay optical system also functions as a protective cover for an ocular optical system.

FIGS. 11(a)-11(c) are schematic illustrations for explaining a Fresnel surface employed in the present invention,

FIG. 12 is an illustration showing optical paths of the entire optical system according to Example 1 of the present invention;

FIG. 13 is an enlarged illustration showing optical paths of the optical system according to Example 1 of the present invention, except optical paths toward the exit pupil;

FIG. 14 is an illustration showing optical paths of the entire optical system according to Example 2 of the present invention;

FIG. 15 is an illustration showing optical paths of the entire optical system according to Example 3 of the present invention;

FIG. 16 is an aberrational diagram showing lateral aberrations in the optical system according to Example 1;

FIG. 17 is an aberrational diagram showing lateral aberrations in the optical system according to Example 2;

FIG. 18 is a diagram showing image distortion in the optical system according to Example 1; and

FIG. 19 is a diagram showing image distortion in the optical system according to Example 2.

### DESCRIPTION OF THE PREFERRED EMBODIMENTS

Hereinafter, embodiments of a display apparatus of the present invention will be described.

Prior to the description of Examples 1 through 3 with concrete numerical values, embodiments for use of the display apparatus of the present invention will be explained.

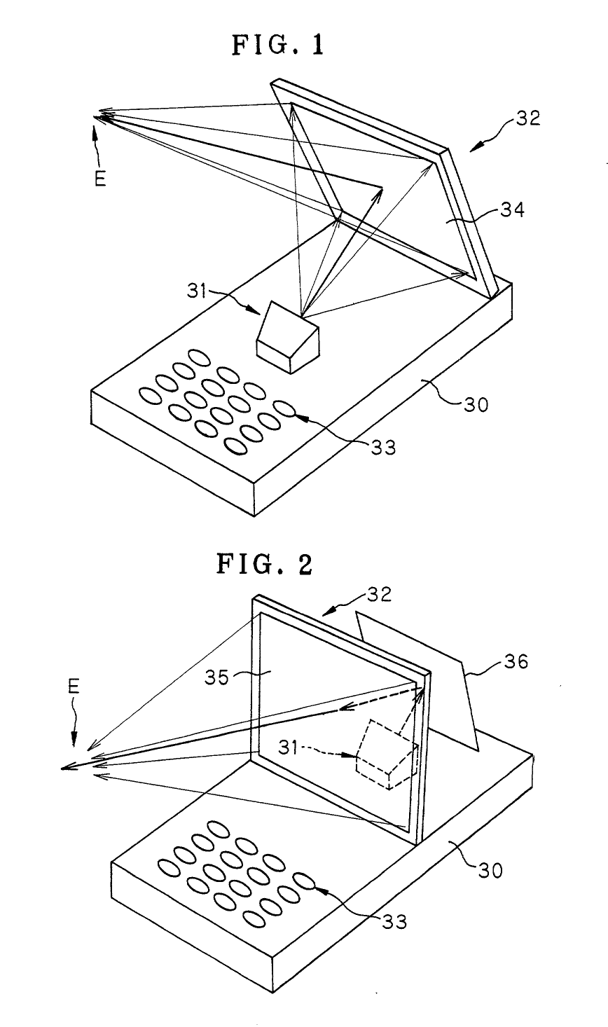

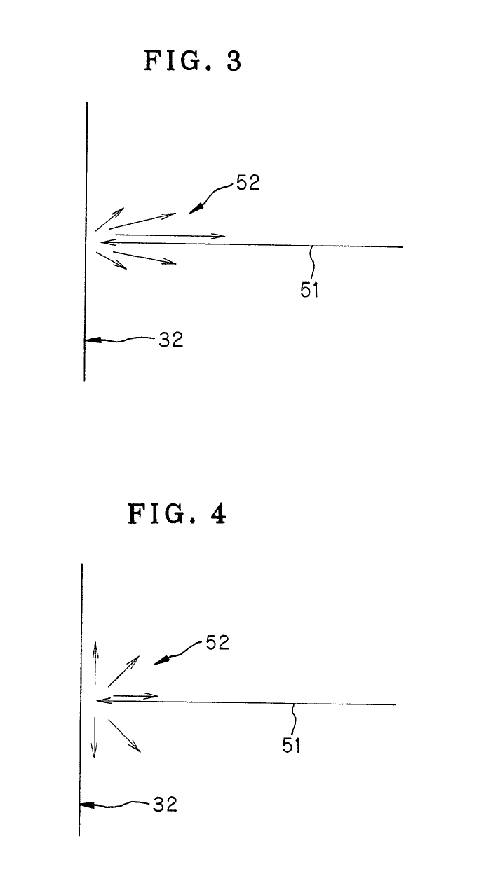

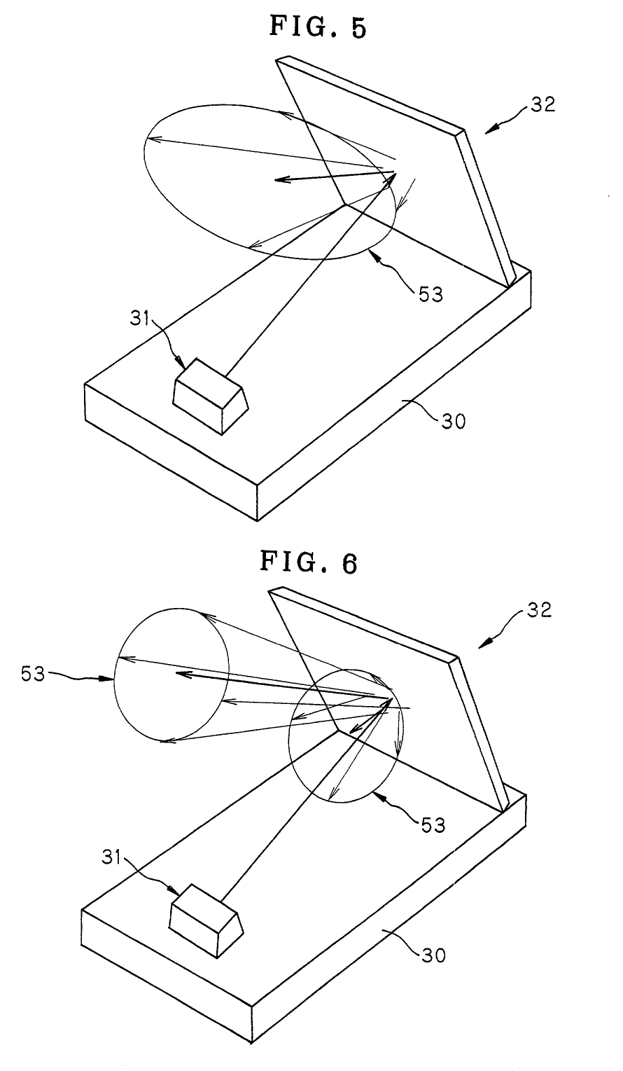

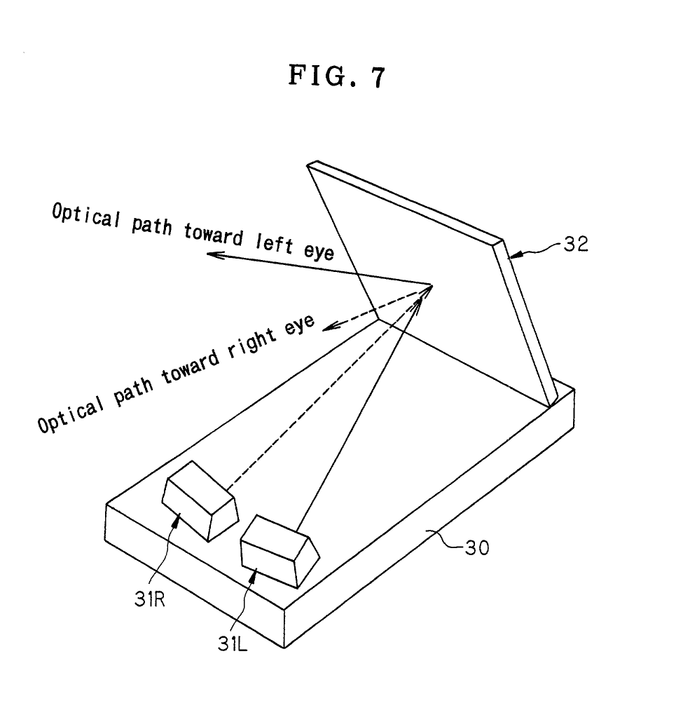

First embodiment for use of the present invention is an apparatus in which an ocular optical system 32 is composed of a Fresnel reflecting surface 34 as shown in FIG. 1. In this case, disposed on a body 30 of the display apparatus are operational buttons 33 and a relay optical system 31 wherein the operational buttons 33 are preferably located on an observer side relative to the relay optical system 31. According to this arrangement, light paths are prevented from being interrupted by a hand operating the operational buttons 33, thereby preventing the problem of interrupting images when the observer operates the buttons. The relay optical system 31 is located on the observer side relative to the ocular optical system 32 whereby the observer can reasonably view images reflected by the ocular optical system 32. In FIG. 1, the position of the observer's eyeballs is indicated by E. It should be noted that an image display element is disposed on the body 30 side of the relay optical system 31, but not illustrated.

In case shown in FIG. 1, the display apparatus is designed to be of a folding type enabling opening/closing of the ocular optical system 32 relative to the body 30 so that the observer can put the apparatus into his/her pocket for carrying it. In this case, it is preferable to add a function of isolating the electric power when closing the ocular optical system 32, thereby increasing the electricity saving efficiency.

The opening of the ocular optical system 32 is preferably achieved by lifting the observer side of the ocular optical system 32 from the body 30, thereby preventing the optical surface of the ocular optical system 32 from being exposed to the outside when closed. Therefore, it is preferable because the optical surface of the optical system is hardly being contaminated.

Second embodiment for use of the present invention is an apparatus in which an ocular optical system 32 is composed of a Fresnel transparent surface 35 as shown in FIG. 2. In this case, disposed on a body 30 of the display apparatus are operational buttons 33 and the ocular optical system 32 wherein the operational buttons 33 are preferably located on an observer side relative to the ocular optical system 32. According to this arrangement, light paths are prevented from being interrupted by a hand operating the operational buttons 33, thereby preventing the problem of interrupting images when the observer operates the buttons. The ocular optical system 32 is located on the observer side relative to a relay optical system 31 whereby the observer can reasonably view images.

In this embodiment, the ocular optical system 32 is preferably closed by putting the ocular optical system 32 down on the relay optical system 31 side. According to this arrangement, the ocular optical system 32 can function as a cover of protecting the relay optical system 31.

In either of the embodiments shown in FIG. 1, FIG. 2, a reflection mirror 36 (FIG. 2) may be located between the relay optical system 31 and the ocular optical system 32 so as to bend light paths, thereby shortening the distance from the relay optical system 31 to the ocular optical system 32. It is further preferable that the reflection mirror 36 is provided with power so that power of the ocular optical system 32 can be dispensed, thereby enabling images to be clearly displayed on a larger display.

The reflection mirror 36 may be arranged to be accommodated below the ocular optical system 32 when closed, thereby preventing the optical element thereof from being exposed and thus improving its dust-proof property.

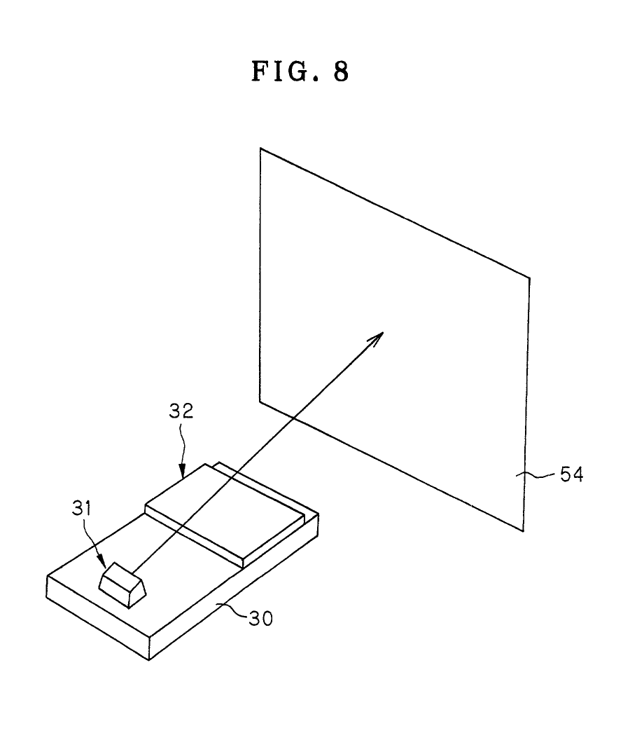

In case of display apparatus of the present invention in which an intermediate image of the display element is formed by the relay optical system and the display apparatus is designed to be of a folding type enabling opening/closing of the ocular optical system 32 relative to the body 30, the display apparatus can be used as a projector for projecting enlarged images to an object such as a wall surface 54 by the relay optical system 31 when the ocular optical system 32 is closed as shown in FIG. 8. In this case, a mechanism for moving the display element to adjust the position of projected image to the wall surface 54.

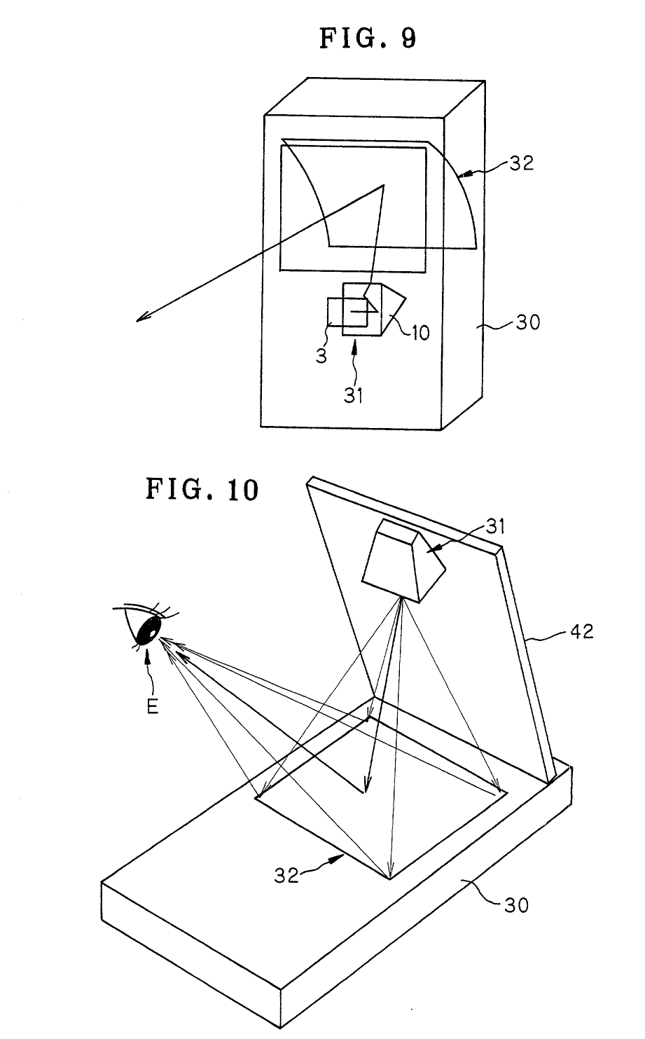

The display apparatus of the present invention is not limited to a portable type as the aforementioned embodiments, the display apparatus may be a hand-held viewer as shown in FIG. 9. The display apparatus of the present invention may also be an arrangement shown in FIG. 10. In this arrangement, a supporting member 42 for a relay optical system 31 also functions as a protection cover for an ocular optical system 32, thereby improving its dust-proof property while being carried with an observer. In FIG. 9, a numeral 3 designates a display element, 10 designates a decentered prism composing the relay optical system 31.

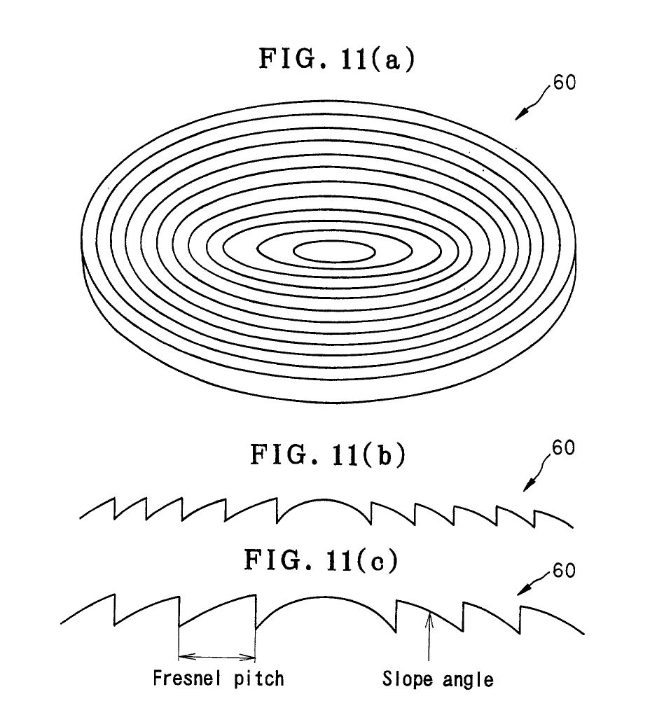

Description will now be made as regard to a Fresnel surface employed in the present invention. A Fresnel surface is formed by cutting an original lenticular curve into multiple ring faces and arranging the ring faces in zona orbicularis. The Fresnel surface employed in the present invention is characterized in that its original lenticular curve has a rotationally asymmetric surface configuration. FIG. 11(a)-11(c) are schematic illustrations of this. FIG. 11(a) is a perspective view of a Fresnel surface 60 employed in the present invention, FIG. 11(b) is a vertical sectional view of the same, and FIG. 11(c) is a lateral sectional view of the same. In the illustrated example, the rotationally asymmetric Fresnel surface 60 is attained by setting the Fresnel pitch in an oval shape which is rotationally asymmetric. Alternatively, the rotationally asymmetric Fresnel surface may be also attained by setting the Fresnel pitch to be rotationally symmetric and setting the slope angle to be rotationally asymmetric. More preferably, similarly to the above, a free-form surface can be fabricated by the method of setting Fresnel pitch rotationally asymmetric or the method of setting the Fresnel pitch to be rotationally symmetric and setting the slope angle to be rotationally asymmetric.

By forming the Fresnel surface 60 to be a refracting surface, a Fresnel transparent surface is obtained. By forming Fresnel surface 60 to be a reflecting surface, a Fresnel reflecting surface is obtained. Incidentally, Fresnel reflecting surface can be obtained by forming the Fresnel surface 60 to be a Fresnel transparent surface and forming another optical surface adjacent to the Fresnel transparent surface to be a reflecting surface.

Now, description will be made as regard to Examples 1 through 3 with concrete numerical values of optical systems to be used in the display apparatus of the present invention.

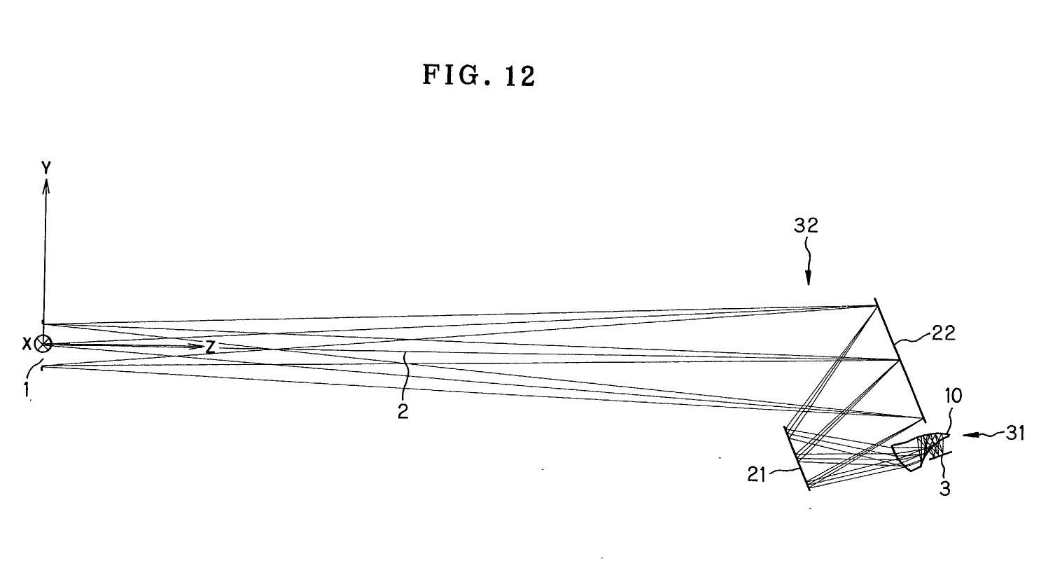

It should be noted that constituent parameters of each example will be shown later. In each example, as shown in FIG. 12, an axial principal ray 2 is defined by a ray passing through the center of the exit pupil 1 (observer's eyeball) to reach the center of the display element 3 according to a reverse ray tracing method in which rays are traced from the position of the exit pupil 1 to the display element 3. Also according to the reverse ray tracing method, as the center of the exit pupil 1 is defined as the origin of decentered optical surfaces of the decentered optical coordinate system, a direction along the axial principal ray 2 is defined as the direction of a Z-axis, a direction from the exit pupil 1 toward a surface facing the exit pupil 1 of the ocular optical system 32 of the optical coordinate system is defined as the positive direction of the Z-axis, a plane equal to the surface of the drawing paper is defined as a Y-Z-plane, a direction extending through the origin, perpendicular to the Y-Z-plane, and directing from the front side to the reverse side of the drawing paper is defined as the positive direction of an X axis, and an axis that constitutes a right-handed orthogonal coordinate system in combination with the X- and Z-axes is defined as a Y-axis.

As for decentered surfaces, each surface is given displacements in the X-, Y- and Z-axis directions (X, Y and Z, respectively) at the vertex position of the surface from the center of the origin of the optical coordinate system, and tilt angles (α, β and γ (°), respectively) of the center axis of the surface (the Z-axis of the aforementioned equation (a) in regard to free-form surfaces; the Z-axis of the following equation (b) in regard to aspherical surfaces) with respect to the X-, Y- and Z-axes. In this case, positive α and β mean counterclockwise rotation relative to the positive directions of the corresponding axes, and positive γ means clockwise rotation relative to the positive direction of the Z-axis. The way of rotating the center axis of the surface for angles α, β, γ will be noted here. First, the center axis of the surface and its XYZ perpendicular coordinate system are rotated by α in the counterclockwise direction about the X-axis, then the center axis of the surface rotated is rotated by β in the counterclockwise direction about the Y-axis of a new coordinate system and further the coordinate system rotated once is also rotated by β in the counterclockwise direction about the Y-axis, and the center axis of the surface rotated twice is rotated by γ in the clockwise direction about the Z-axis of a new coordinate system.

The configuration of each free-form surface used in the present invention is defined by the equation (a) of U.S. Pat. No. 6,124,989 (Japanese Patent Unexamined Publication 2000-66105). The Z-axis of the defining equation is the axis of the free-form surface.

In the constituent parameters, terms concerning free-form surfaces for which no data is shown are zero. The refractive index is expressed by the refractive index for the spectral d-line (wavelength: 587.56 nm). Lengths are given in millimeters.

In Example 1, the horizontal viewing field angle is 10°, and the vertical viewing field angle is 7.5°. The pupil diameter φ15 mm, the distance from the exit pupil 1 corresponding to the observer's eye position to the image is 30 cm, the position of the exit pupil is 30 cm. A display element 3 of 4.8 mm×3.2 mm is used.

In Example 2, the horizontal viewing field angle is 10°, and the vertical viewing field angle is 7.5°. The pupil diameter φ15 mm, the distance from the exit pupil corresponding to the observer's eye position to the image is 1 m, the position of the exit pupil is 30 cm. A display element 3 of 20.3 mm×15.2 mm is used.

In Example 3, the horizontal viewing field angle is 6°, and the vertical viewing field angle is 8°. The pupil diameter φ15 mm, the distance from the exit pupil corresponding to the observer's eye position to the image is 1 m, the position of the exit pupil is 20 cm. A display element 3 of 10.7 mm×14.2 mm, that is with longer vertical length, is used.

Though the following examples are designed based on that the ocular optical system 32 has no diffusion property, the objective surface of the ocular optical system 32 may be provided with a reflecting surface including a Fresnel reflecting surface and this reflecting surface may have diffusion property, thereby making the optical system which can prevent vignetting affect from being produced even when the observer somewhat moves his eyes.

Now, the structure of the optical systems of the respective examples will be explained.

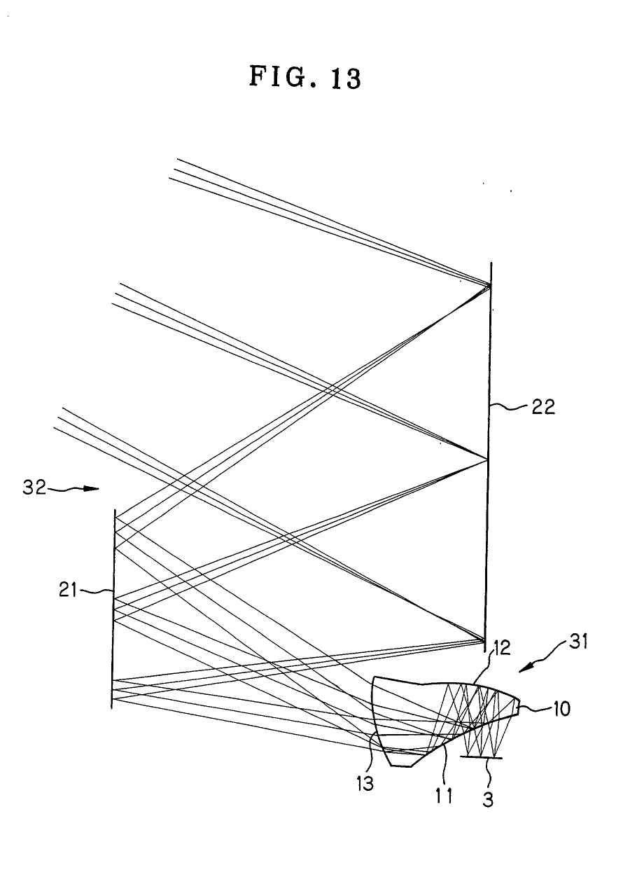

The optical system of Example 1 is shown in FIG. 12 which is an illustration entirely showing optical paths thereof and in FIG. 13 which is an enlarged illustration showing optical paths thereof except optical paths toward the exit pupil. An ocular optical system 32 facing the exit pupil 1 comprises a first Fresnel reflecting mirror 21 and a second Fresnel reflecting mirror 22 which are disposed to form Z-like optical paths. A relay optical system 31 facing the display element 3 comprises a decentered prism 10. The decentered prism 10 of this example comprises a first facet 11 facing the display element 3, a third facet 13 facing the first Fresnel reflecting mirror 21, and a second facet 12. As a ray from the display element 3 is refracted by the first facet 11 and is incident into the prism, the ray is reflected at the second surface 12 and is incident on the first facet 11 again. At this time, however, the ray is entirely reflected at the first facet 11. The reflected ray is refracted by the third facet 13 to exit from the prism. Then, the ray is reflected at the first Fresnel reflecting mirror 21 to form an intermediate image, corresponding to the image on the display element 3, near the second Fresnel reflecting mirror 22. The first facet 11 functions both as an incident surface and a first reflecting surface.

In this example, the first Fresnel reflecting mirror 21, the second Fresnel reflecting mirror 22, the first through third facets 11-13 of the decentered prism 10 are all composed of free-form surfaces.

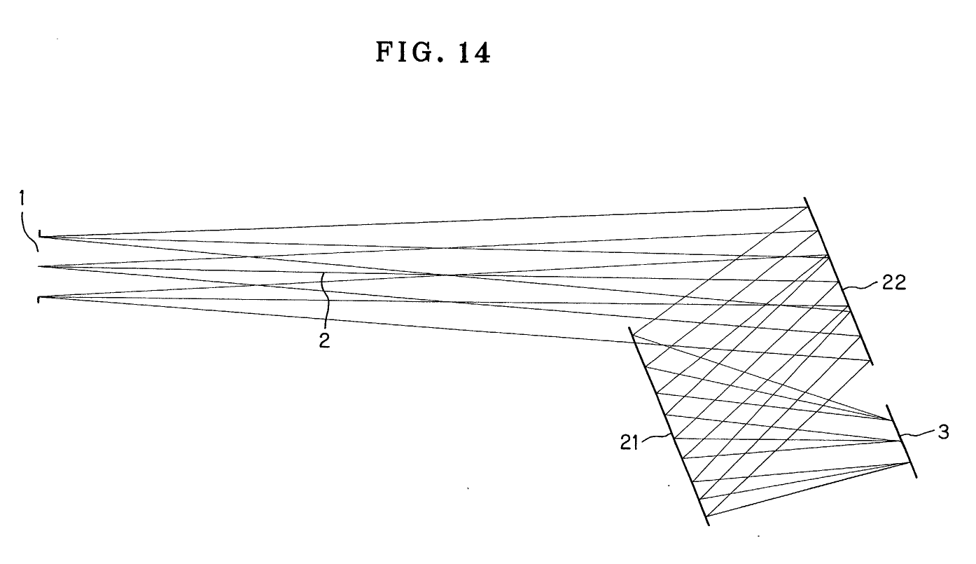

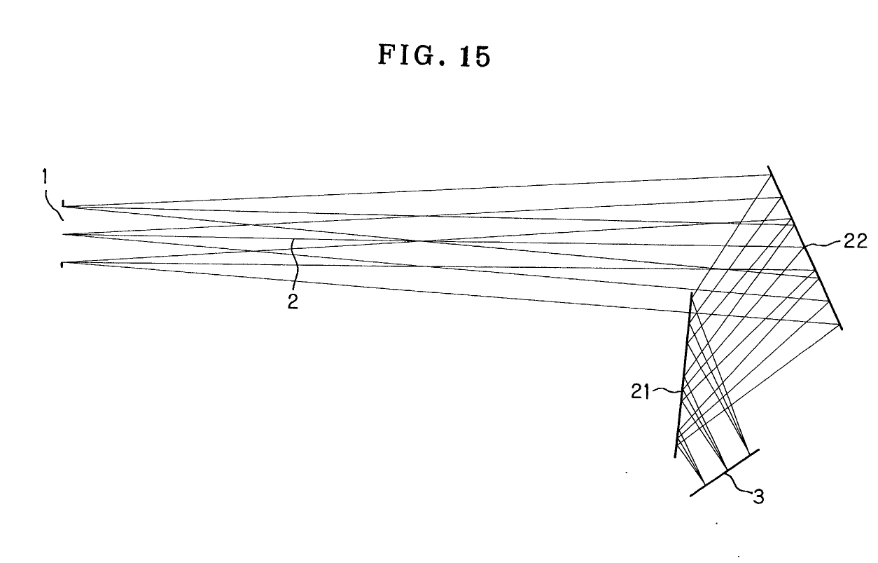

The optical systems of Examples 2, 3 are shown in FIG. 14, FIG. 15 which are illustrations entirely showing optical paths, respectively. Each optical system has no relay optical system and is composed of only ocular optical system 32 which comprises a first Fresnel reflecting mirror 21 facing the display element 3 and a second Fresnel reflecting mirror 22 which are disposed to form Z-like optical paths. In either of Examples 2, 3, the first Fresnel reflecting mirror 21 and the second Fresnel reflecting mirror 22 are all composed of free-form surfaces.

Constituent parameters in the respective examples are shown below. In the tables below, “FFS” denotes a free-form surface, “AAS” denotes an aspheric surface, “RE” denotes a reflecting surface, and “FR” denotes a Fresnel reflecting plane.

Example 1

| Surface | Radius of | Surface | Displacement | Refractive | Abbe's |
|---|---|---|---|---|---|
| No. | curvature | separation | and tilt | index | No. |
| Object | ∞ | −300.00 | | | |
| plane | | | | | |
| 1 | ∞ (Pupil) | | | | |
| 2 | FFS\mathring{1} (FR) | | (1) | | |
| 3 | FFS\mathring{2} | | (2) | 1.5254 | 56.2 |
| 4 | FFS\mathring{3} (RE) | | (3) | 1.5254 | 56.2 |
| 5 | FFS\mathring{4} (RE) | | (4) | 1.5254 | 56.2 |
| 6 | FFS\mathring{3} | | (3) | | |
| Image | ∞ | | (5) | | |
| plane | | | | | |

FFS1

| | | | | | |
|---|---|---|---|---|---|
| C₄ | −3.9387 × 10⁻³ | C₆ | −2.9739 × 10⁻³ | C₈ | 4.1227 × 10⁻⁶ |
| C₁₀ | 8.8753 × 10⁻⁶ | C₁₁ | 1.7151 × 10⁻⁷ | C₁₃ | 3.3897 × 10⁻⁷ |
| C₁₅ | −9.8541 × 10⁻⁸ | | | | |

FFS2

| | | | | | |
|---|---|---|---|---|---|
| C₄ | 3.1431 × 10⁻² | C₆ | 4.0019 × 10⁻² | C₈ | 1.1742 × 10⁻³ |
| C₁₀ | −5.0916 × 10⁻⁴ | | | | |

FFS3

| | | | | | |
|---|---|---|---|---|---|
| C₄ | 1.3059 × 10⁻² | C₆ | 1.2974 × 10⁻² | C₈ | 4.8944 × 10⁻⁴ |
| C₁₀ | 3.3628 × 10⁻⁴ | | | | |

FFS4

| | | | | | |
|---|---|---|---|---|---|
| C₄ | 2.7949 × 10⁻² | C₆ | 2.9262 × 10⁻² | C₈ | 8.9030 × 10⁻⁴ |
| C₁₀ | 1.0544 × 10⁻³ | | | | |

Displacement and tilt(1)

| | | | | | |
|---|---|---|---|---|---|
| X | 0.00 | Y | 0.00 | Z | 300.00 |
| α | 22.50 | β | 0.00 | γ | 0.00 |

Displacement and tilt(2)

| | | | | | |
|---|---|---|---|---|---|
| X | 0.00 | Y | −35.00 | Z | 300.00 |
| α | 36.94 | β | 0.00 | γ | 0.00 |

Displacement and tilt(3)

| | | | | | |
|---|---|---|---|---|---|
| X | 0.00 | Y | −31.80 | Z | 310.33 |
| α | −40.44 | β | 0.00 | γ | 0.00 |

Displacement and tilt(4)

| | | | | | |
|---|---|---|---|---|---|
| X | 0.00 | Y | −25.62 | Z | 309.81 |
| α | −76.12 | β | 0.00 | γ | 0.00 |

Displacement and tilt(5)

| | | | | | |
|---|---|---|---|---|---|
| X | 0.00 | Y | −33.38 | Z | 313.50 |
| α | 110.47 | β | 0.00 | γ | 0.00 |

Example 2

| Surface | Radius of | Surface | Displacement | Refractive | Abbe's |
|---|---|---|---|---|---|
| No. | curvature | separation | and tilt | index | No. |
| Object | ∞ | −1000.00 | | | |
| plane | | | | | |
| 1 | ∞ (Pupil ) | | | | |
| 2 | FFS\mathring{1} (FR) | | (1) | | |
| 3 | FFS\mathring{2} (FR) | | (2) | | |
| Image | ∞ | | (3) | | |
| plane | | | | | |

FFS1

| | | | | | |
|---|---|---|---|---|---|
| C₄ | 4.8533 × 10⁻⁴ | C₆ | −1.3648 × 10⁻⁴ | C₈ | 3.2818 × 10⁻⁵ |
| C₁₀ | 2.4846 × 10⁻⁵ | C₁₁ | −1.7848 × 10⁻⁷ | C₁₃ | 3.9758 × 10⁻⁷ |
| C₁₅ | 3.0958 × 10⁻⁷ | | | | |

FFS2

| | | | | | |
|---|---|---|---|---|---|
| C₄ | 4.3999 × 10⁻³ | C₆ | 3.4186 × 10⁻³ | C₈ | 6.1583 × 10⁻⁶ |
| C₁₀ | 4.7568 × 10⁻⁶ | C₁₁ | −2.1145 × 10⁻⁷ | C₁₃ | −1.5487 × 10⁻⁷ |
| C₁₅ | −7.5332 × 10⁻⁸ | | | | |

Displacement and tilt(1)

| | | | | | |
|---|---|---|---|---|---|
| X | 0.00 | Y | 0.00 | Z | 200.00 |
| α | 22.50 | β | 0.00 | γ | 0.00 |

Displacement and tilt(2)

| | | | | | |
|---|---|---|---|---|---|
| X | 0.00 | Y | −40.00 | Z | 160.00 |
| α | 22.50 | β | 0.00 | γ | 0.00 |

Displacement and tilt(3)

| | | | | | |
|---|---|---|---|---|---|
| X | 0.00 | Y | −40.00 | Z | 216.00 |
| α | 22.50 | β | 0.00 | γ | 0.00 |

Example 3

| Surface | Radius of | Surface | Displacement | Refractive | Abbe's |
|---|---|---|---|---|---|
| No. | curvature | separation | and tilt | index | No. |
| Object | ∞ | −1000.00 | | | |
| plane | | | | | |
| 1 | ∞ (Pupil) | | | | |
| 2 | FFS\mathring{1} (FR) | | (1) | | |
| 3 | FFS\mathring{2} (FR) | | (2) | | |
| Image | ∞ | | (3) | | |
| plane | | | | | |

FFS1

| | | | | | |
|---|---|---|---|---|---|
| C₄ | −3.1672 × 10⁻³ | C₆ | −2.5388 × 10⁻³ | C₈ | 1.6404 × 10⁻⁵ |
| C₁₀ | 1.2577 × 10⁻⁵ | C₁₁ | 4.5460 × 10⁻⁸ | C₁₃ | 2.3019 × 10⁻⁷ |
| C₁₅ | 6.9490 × 10⁻⁸ | | | | |

FFS2

| | | | | | |
|---|---|---|---|---|---|
| C₄ | −1.3376 × 10⁻³ | C₆ | −2.3139 × 10⁻⁴ | C₈ | 8.5736 × 10⁻⁵ |
| C₁₀ | 2.1379 × 10⁻⁵ | C₁₁ | −3.4468 × 10⁻⁷ | C₁₃ | −1.1621 × 10⁻⁶ |
| C₁₅ | −3.9019 × 10⁻⁷ | | | | |

Displacement and tilt(1)

| | | | | | |
|---|---|---|---|---|---|
| X | 0.00 | Y | 0.00 | Z | 200.00 |
| α | 25.00 | β | 0.00 | γ | 0.00 |

Displacement and tilt(2)

| | | | | | |
|---|---|---|---|---|---|
| X | 0.00 | Y | −35.00 | Z | 168.00 |
| α | −5.07 | β | 0.00 | γ | 0.00 |

Displacement and tilt(3)

| | | | | | |
|---|---|---|---|---|---|
| X | 0.00 | Y | −60.50 | Z | 180.06 |
| α | −55.00 | β | 0.00 | γ | 0.00 |

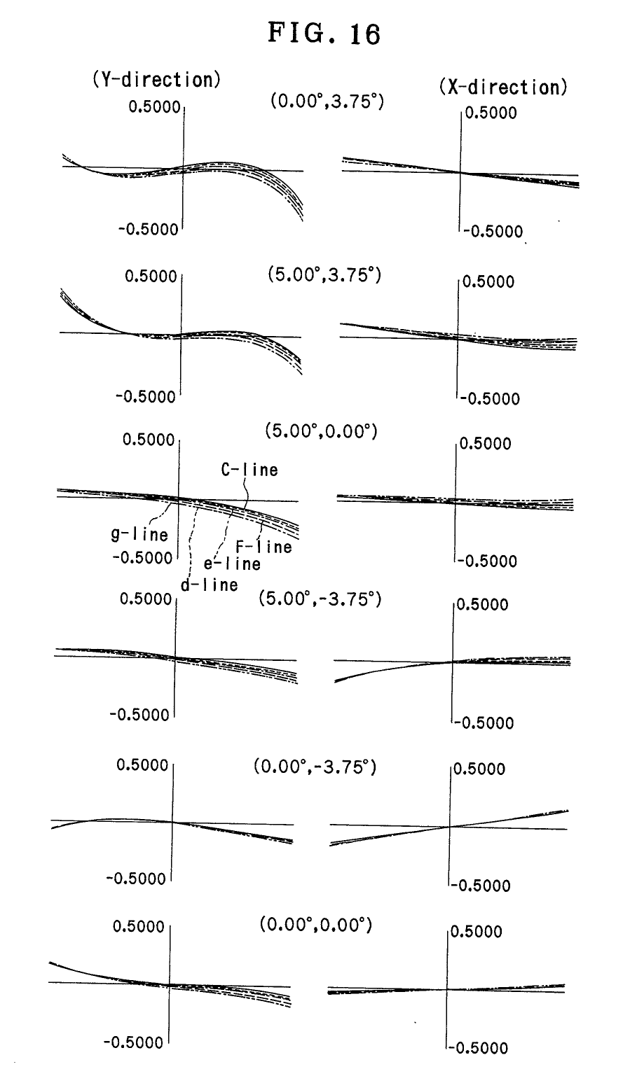

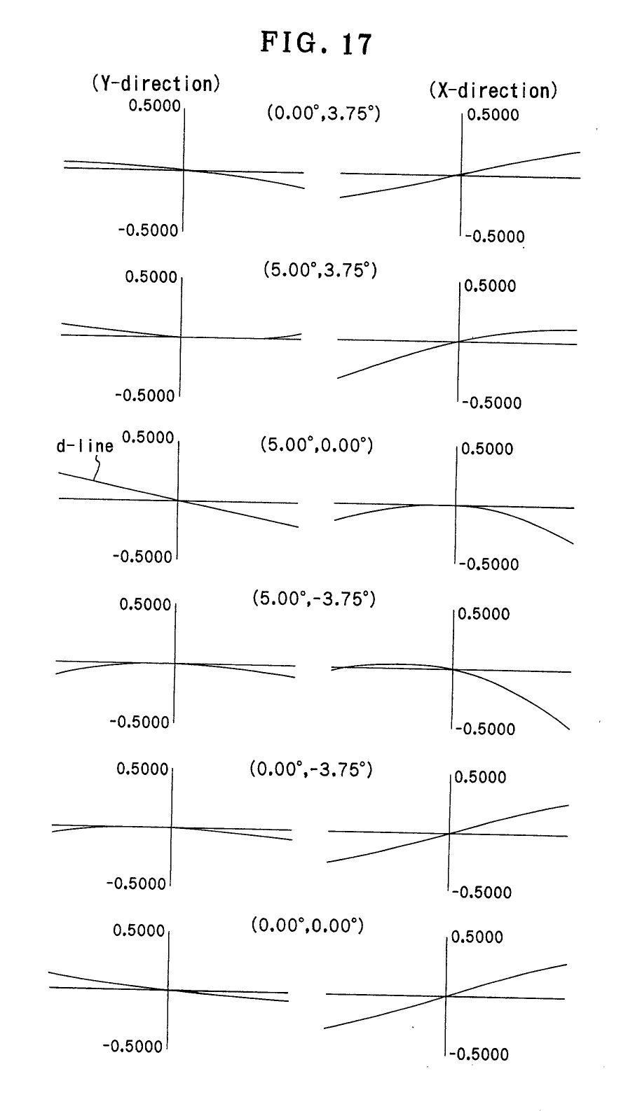

FIGS. 16 and 17 show lateral aberrations in the aforementioned Examples 1 and 2. In the diagrams showing lateral aberrations, the numerals in the parentheses denote (horizontal field angle, vertical field angle), showing lateral aberrations at the field angles, respectively.

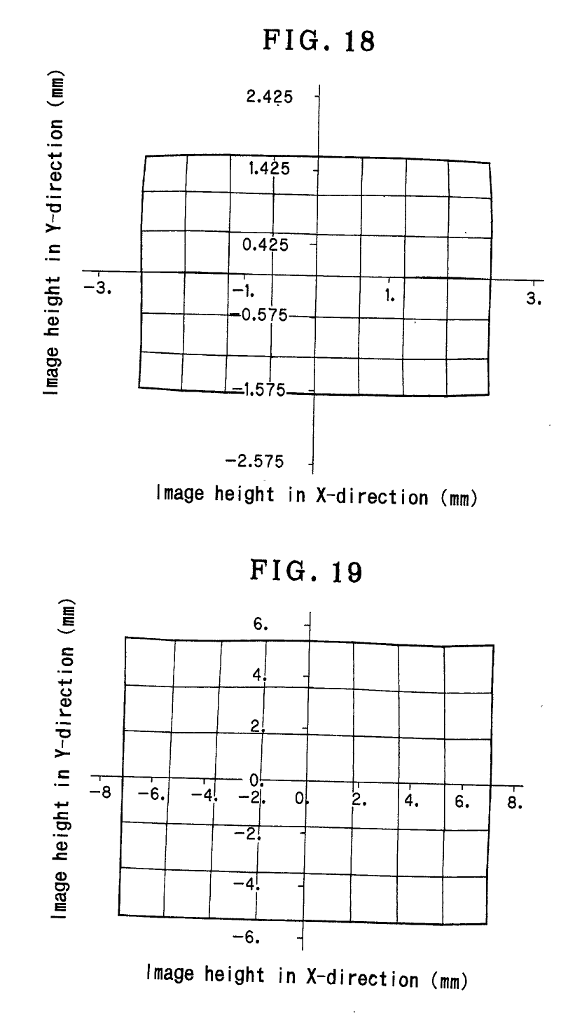

FIGS. 18 and 19 are diagrams showing image distortion in Examples 1 and 2, respectively.

It should be noted that, in case of using a relay optical system, a decentered prism is not limited to the decentered prism, employed in Example 1, of a type in which inside reflection is conducted twice and may be another known type decentered prism or a combination of such decentered prisms. The number of Fresnel reflecting mirrors (Fresnel reflecting surfaces) employed as the ocular optical system is not limited to two and may be one, or three or more. Further, among the reflecting surfaces, one or more of the reflecting surfaces may be constituted of a plane mirror or a curved mirror.

As apparent from the above description, the present invention can provide a small-sized portable display apparatus in which the exit pupil position is relatively spaced apart form the optical system and the exit pupil diameter is large.

What we claim is:

1. A display apparatus comprising: a display element for displaying an image, and an ocular optical system for enlarging an image displayed on said display element or an intermediated image thereof as a virtual image, said display apparatus being characterized in that said ocular optical system has a rotationally asymmetric Fresnel surface.

2. A display apparatus as claimed in claim 1, being characterized in that said rotationally asymmetric Fresnel surface is composed of a free-form surface.

3. A display apparatus as claimed in claim 1, being characterized in that said rotationally asymmetric Fresnel surface is disposed in a decentered position and is arranged to correct decentration aberrations created due to its decentration.

4. A display apparatus as claimed in claim 1, being characterized in that said Fresnel surface is a Fresnel reflecting surface.

5. A display apparatus as claimed in claim 1, being characterized in that said Fresnel surface is a Fresnel transparent surface.

6. A display apparatus as claimed in claim 1, being characterized by satisfying the following conditional expression:
80 mm<EXPe<1000 mm (1)
wherein EXPe is an axial distance from the exit pupil position in said ocular optical system to a surface of said ocular optical system facing the exit pupil.

7. A display apparatus as claimed in claim 1, being characterized in that when the direction of an optical axis is defined by the direction of a Z-axis, the decentering direction of an optical plane is defined by the direction of a Y-axis, and the direction perpendicular to both of the Z- and Y-axes is defined by the direction of X-axis, at least one of said rotationally asymmetric Fresnel surfaces is arranged such that power in the direction of the X-axis and power in the direction of the Y-axis are both gradually stronger with getting closer to the direction toward the position of said display element.

8. A display apparatus as claimed in claim 1, being characterized by further comprising a relay optical system for forming an intermediate image corresponding to the image on said display element, wherein the intermediate image projected by said relay optical system is formed near said ocular optical system.

9. A display apparatus as claimed in claim 8, being characterized in that said relay optical system is made of a medium of which refractive index (n) is greater than 1, i.e. n>1, and comprises an incident facet which allows light beam from said display element to enter a prism, at least one reflecting facet which reflects the light beam inside the prism, and an exit facet which allows the light beam to exit from the prism, wherein said at least one reflecting facet is composed of one or a plurality of decentered prisms having curved surface configurations for imparting power to the light beam.

10. A display apparatus as claimed in claim 1, being characterized in that said ocular optical system has diffusion property.

11. A display apparatus as claimed in claim 1, being characterized in that said ocular optical system has diffusion property at least in one dimensional direction.

12. A display apparatus as claimed in claim 1, being characterized in that said ocular optical system has two axes in different directions, wherein said ocular optical system has diffusion property about each of the two axes.

13. A display apparatus as claimed in claim 1, being characterized in that said ocular optical system has diffraction optical element.

14. A display apparatus as claimed in claim 1, being characterized in that said ocular optical system has hologram optical element.

15. A display apparatus as claimed in claim 8, being characterized by comprising two said display elements, two said relay optical systems to correspond to said display elements, and said ocular optical system which is common to said two relay optical systems.

16. A display apparatus as claimed in claim 8, being characterized in that the position of said display element relative to said relay optical system is adjustable.

17. A display apparatus as claimed in claim 8, being characterized in that said ocular optical system is enable to escape from optical paths so that said display apparatus can be used as a projector.

18. A display apparatus as claimed in claim 8, being characterized in that said position of said display element relative to said relay optical system is adjustable.
